(19) United States
(12) Patent Application Publication
(10) Pub. No.: US 2007/0057633 A1
(43) Pub. Date: Mar. 15, 2007

(54) Plasma display panel

(76) Inventors: Taewoo Kim, Yongin-si (KR); Sanghoon Yim, Yongin-si (KR); Youngkee Kim, Yongin-si (KR); Jaerok Kim, Yongin-si (KR); Jeongdoo Yi, Yongin-si (KR); Min Hur, Yongin-si (KR)

Correspondence Address: CHRISTIE, PARKER & HALE, LLP, PO BOX 7068, PASADENA, CA, 91109-7068, US

(21) Appl. No.: 11/516,169

(22) Filed: Sep. 5, 2006

(30) Foreign Application Priority Data
Sep. 6, 2005 (KR) 2005-0082846

(51) Int. Cl. H01J 1/62

(52) U.S. Cl. 313/506

(57) ABSTRACT

A plasma display panel has two address electrodes assigned to a pixel to reduce power consumption without degrading resolution and has as large a gap as possible between bus electrodes inside a discharge cell to improve discharge efficiency and luminance. Three closest discharge cells emitting different colors of visible rays define a pixel. Two address electrodes are assigned to each pixel. Two display electrodes are assigned to the respective discharge cells of each pixel, the direction of the display electrodes intersecting with the the direction of the address electrodes. The display electrodes are bent towards a periphery of each discharge cell to increase the gap between the display electrodes inside the discharge cell.

### CROSS RERERENCE TO RELATED APPLICATION

This application claims priority to and the benefit of Korean Patent Application No. 10-2005-0082846 filed on Sept. 6, 2005 in the Korean Intellectual Property Office, the entire content of which is incorporated herein by reference.

### BACKGROUND OF THE INVENTION

1. Field of the Invention

The present invention relates to a plasma display panel (PDP), and more particularly, to a PDP having reduced power consumption and improved discharge efficiency and luminance.

2. Description of the Prior Art

Conventional PDPs include a front glass substrate having a number of display electrodes (scan electrodes and sustain electrodes) and a rear glass substrate having a number of address electrodes, whose direction intersects with the direction of the display electrodes. A number of barriers are formed between the front and rear glass substrates to delimit a number of discharge cells. Among the discharge cells delimited by the barriers, three closest discharge cells, which emit different colors of visible rays, are defined as a pixel. Each discharge cell has red, green, and blue fluorescent layers. In general, each pixel has three address electrodes assigned thereto. As a result, three address electrodes are assigned to three discharge cells.

As recent PDPs are highly integrated for better resolution, the number of address electrodes gradually increases, while the pitch between them decreases. As widely known in the art, when the pitch between address electrodes decreases, the capacitance between the address electrodes increases and the amount of energy consumed between the address electrodes is approximately calculated as CV²f, where C is capacitance created between the address electrodes, V is voltage applied to the address electrodes, and f is frequency applied to the address electrodes.

In order to manufacture high-resolution PDPs, increase in power (CV² f) consumed by address electrodes is unavoidable. In addition, increase in power consumption of address electrodes is directly connected to increase in overall power consumption of PDPs, because discharge voltage applied to the address electrodes is much larger than that applied to the display electrodes. In the case of a full HD grade of 1920×1080, for example, 1920 pixels (5760 discharge cells) are required for horizontal resolution. In order to satisfy this requirement, no less than 5760 address electrodes are necessary, because each discharge cell has a number of address electrodes assigned thereto. As a result, the amount of power consumed by PDPs increases abruptly and, as the distance between address electrodes decreases, crosstalk occurs severely. In addition, circuits (e.g. tape carrier packages) for applying a predetermined voltage to the address electrodes must endure larger instantaneous power (or peak power), and the amount of heat generated by the circuits or panels increases abruptly.

The display electrodes formed on the front glass substrate include transparent electrodes deposited on the front glass substrate to improve the transmittance of visible rays and bus electrodes deposited on the transparent electrodes′surface with a smaller line width to avoid voltage drop resulting from high resistance of the transparent electrodes.

In general, the bus electrodes cross approximately the center of the transparent electrodes and have an approximately linear form along the entire rows or columns. Therefore, there are some limitations in magnifying the gap between linear bus electrodes. This blocks the improvement of discharge efficiency (sustain discharge efficiency).

It is known in the art that the larger the gap between the bus electrodes is, the better the sustain discharge efficiency and luminance are. If the gap between conventional bus electrodes, which are approximately linear, is increased, there is a possibility that other discharge cells generate erroneous discharge. As a result, the gap between the bus electrodes cannot be sufficiently increased to improve the sustain discharge efficiency and luminance.

In addition, the bus electrodes are positioned adjacent to the center of the discharge cells and shield visible rays from the center of the discharge cells. This degrades the luminance.

### SUMMARY OF THE INVENTION

In accordance with the present invention a PDP is provided having two address electrodes assigned to a pixel to reduce power consumption without degrading resolution and as large a gap as possible between bus electrodes inside a discharge cell to improve sustain discharge efficiency and luminance.

In an embodiment of the present invention a PDP is provided wherein a front glass substrate has a front glass substrate surface. A rear glass substrate has a rear glass substrate surface facing the front glass substrate surface. Discharge cells are formed in regions of the rear glass substrate defined by barriers having a predetermined thickness, the discharge cells being adapted to emit predetermined colors of visible rays, three closest discharge cells emitting different colors of visible rays and defining a pixel. A plurality of display electrodes are formed in a first direction on the front glass substrate surface. A plurality of address electrodes are formed in a second direction on the rear glass substrate surface, the second direction being substantially perpendicular to the first direction. Two of the plurality of address electrodes are associated with each pixel, one of the two of the plurality of address electrodes being associated with a respective discharge cell of the pixel, the other of the two of the plurality of address electrodes being associated with the other two discharge electrodes of the pixel. A pair of display electrodes of the plurality of display electrodes are associated with the respective discharge cell, the direction of the pair of display electrodes intersecting within a respective discharge cell with a direction of the one of the two of the plurality of address electrodes associated with the respective discharge cell. The display electrodes extend towards a periphery of each discharge cell at a center region of the discharge cell such that an increased gap is provided between the display electrodes inside the discharge cell.

An address electrode may be commonly assigned to two selected discharge cells of the three discharge cells defining a pixel, and the other of the two of the plurality of address electrode may be assigned to a remaining discharge cell of the pixel, the address electrode commonly assigned being substantially parallel with the other address electrode.

The discharge cells may have a polygonal shape enclosed by the barriers.

The display electrodes may include bus electrodes and transparent electrodes extending from the bus electrodes within the discharge cell. The bus electrodes may extend along the periphery of each discharge cell at the center region of the discharge cell such that the increased gap is provided between the display electrodes inside the discharge cell. The transparent electrodes extend from the bus electrodes at the widest parts of the discharge cells, the widest parts intersecting with second direction.

The bus electrodes may include parallel portions formed at the periphery of each discharge cell at the center region of the discharge cell and slanted portions connected to the parallel portions and extending outside the discharge cell. Each slanted portion of the bus electrodes may extend outside the discharge cell through a center of a side of a barrier defining the discharge cell. A gap between the parallel portions of the bus electrodes inside each discharge cell may be larger than a gap between parallel portions of adjacent bus electrodes of two adjacent discharge cells adjacent the each discharge cell and adjacent to each other along the second direction. The parallel portions may extend in the first direction.

### BRIEF DESCRIPTION OF THE DRAWINGS

FIG. 1 is a perspective view showing a PDP according to an embodiment of the present invention.

FIG. 2 schematically shows the relationship among display electrodes formed on a front glass substrate, barriers formed on a rear glass substrate, and address electrodes formed on the rear glass substrate in a PDP according to an embodiment of the present invention.

FIG. 3 schematically shows the relationship between display electrodes and pixels in a PDP according to an embodiment of the present invention.

FIG. 4 is a perspective view showing the relationship between display electrodes and a discharge cell (sub-pixel) in a PDP according to an embodiment of the present invention.

FIG. 5 is a sectional view showing a PDP according to an embodiment of the present invention.

### DETAILED DESCRIPTION

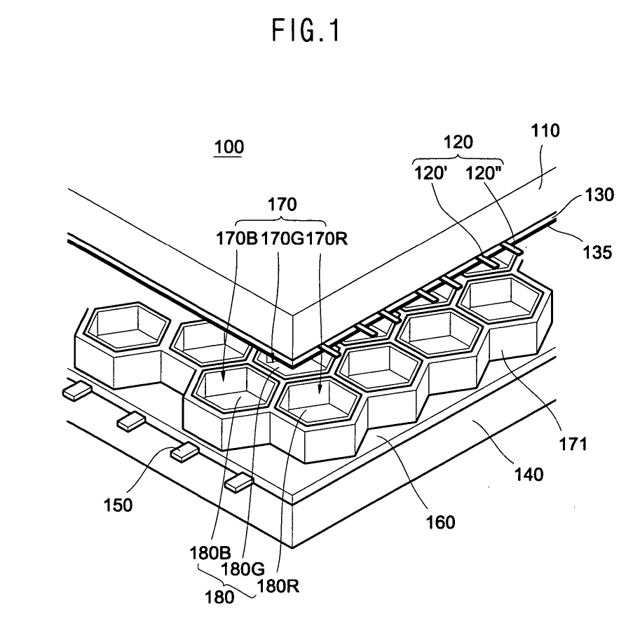

Referring now to FIG. 1, the PDP 100 according to an embodiment of the present invention includes a front glass substrate 110. A number of display electrodes 120 are formed on the front glass substrate 110. A first dielectric layer 130 covers the display electrodes 120. A rear glass substrate 140 is positioned so as to face the front glass substrate 110. A number of address electrodes 150 are formed on the rear glass substrate 140. A second dielectric layer 160 covers the address electrodes 150. A number of discharge cells 170 are delimited on the second dielectric layer 160 by barriers 171 having a predetermined thickness. Fluorescent layers 180 are formed in the respective discharge cells 170.

The front glass substrate 110 may be made of a substantially planar PD 200 glass, soda lime glass, plastic, or an equivalent thereof, which has good heat-resistance and high strain point enough to retain its dimension and shape in various high-temperature processes, but the material is not limited to that herein.

The display electrodes 120 are formed on the lower surface of the front glass substrate 110 substantially parallel to one another with a predetermined pitch. The display electrodes 120 include scan electrodes 120′ and sustain electrodes 120″. The structure and function of the display electrodes 120 will be described later in more detail.

The first dielectric layer 130 covers the entire lower surface of the front glass substrate 110, including the display electrodes 120. The first dielectric layer 130 may be formed by uniformly screen-printing paste, which includes low melting point glass powers as the main component, on the entire lower surface of the front glass substrate 110. As widely known in the art, the first dielectric layer 130 is transparent and functions as a capacitor during discharge. In addition, the first dielectric layer 130 limits the current and acts as a memory. The first dielectric layer 130 may have a protective film 135 formed on a surface thereof to reinforcement durability and discharge more secondary electrons during discharge. The protective film 135 may be made of MgO or an equivalent thereof in an electron beam mode or by sputtering. However, other material and formation method of the protective film may be used.

The rear glass substrate 140 is positioned so as to face the front glass substrate 110, the rear glass substrate 140 being positioned below the first dielectric layer 130. The rear glass substrate 140 may be made of substantially planar PD 200 glass, soda lime glass, plastic, or an equivalent thereof, which has good heat-resistance and high strain point so as to retain its dimension and shape in various high-temperature processes, but the material is not limited to that herein.

The address electrodes 150 are formed on the upper surface of the rear glass substrate 140, which faces the first dielectric layer 130 of the front glass substrate 110. The address electrodes 150 are formed on the upper surface of the rear glass substrate 140 substantially parallel to one another with a predetermined pitch. For example, the address electrodes 150 are arranged in a number of rows with a predetermined pitch. The direction of the address electrodes 150 intersect with the direction of the display electrodes 120. The address electrodes 150 may be substantially perpendicular to the display electrodes 120. As will be described later, each address electrode 150 intersects with discharge cells 170, which emit different colors of visible rays, or different fluorescent layers 180. The address electrodes 150 may be of Ag paste or an equivalent thereof and formed by sputtering, a screen printing method, or photolithography. However, the material and formation method of the address electrodes 150 are not limited to such material or technique.

The second dielectric layer 160 covers the entire upper surface of the rear glass substrate 140, including the address electrodes 150. The second dielectric layer 160 may be made of a similar or identical material as that of the first dielectric layer 130.

The discharge cells 170 are delimited on a surface of the second dielectric layer 160 by barriers 171 having a predetermined thickness. For example, a discharge cell 170 is delimited in every region, where a display electrode 120 and an address electrode 150 overlap each other, in an approximately matrix configuration. The discharge cells 170 may have any shape chosen from a triangle, a square, a lozenge, a pentagon, a hexagon, and a polygon. Although hexagonal dosed-type discharged cells 170 are shown in the drawing, the shape is not limited to such an embodiment, and the present invention can be applied to all kinds of dosed-type discharge cells 170. The barriers 171 maintain a spacing between the front and rear glass substrates 110, 140 and delimit a number of discharge cells 170, as mentioned above. The barriers 171 may be made of low melting point glass powder paste or an equivalent thereof by a screen printing method, a sand blast method, a lift-off method, or etching. However, the material and formation method of the barriers 171 are not limited to such material or technique. In the drawing, reference numeral 170R refers to a red discharge cell for emitting red light, 170G refers to a green discharge cell for emitting green light, and 170B refers to a blue discharge cell for emitting blue light.

The fluorescent layers 180 are formed on the inner wall of the discharge cells 170 (or inner wall of the barriers) and on the second dielectric layer 160 with a predetermined thickness. The fluorescent layers 180 are excited by UV rays, which are generated during discharge, and emit predetermined colors of visible rays. The red, green, and blue discharge cells 170R, 170G, 170B have red, green, and blue fluorescent layers 180R, 180G, 180B formed therein, respectively.

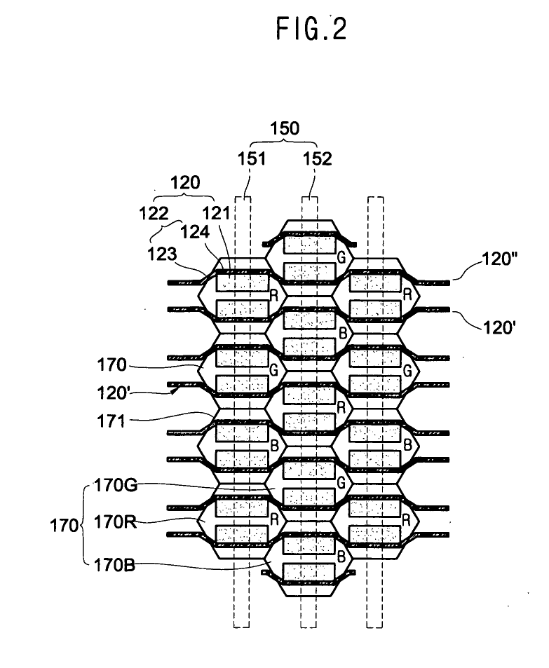

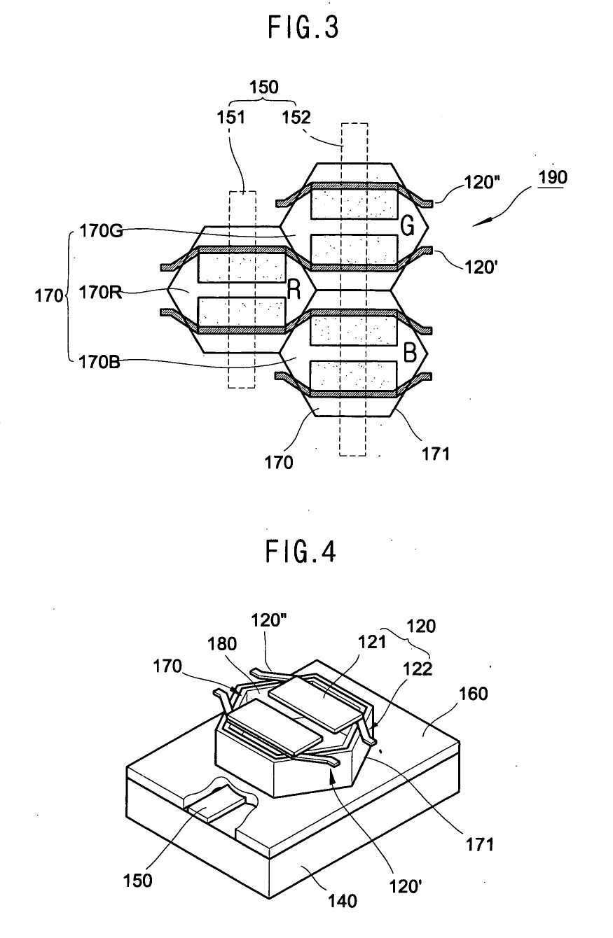

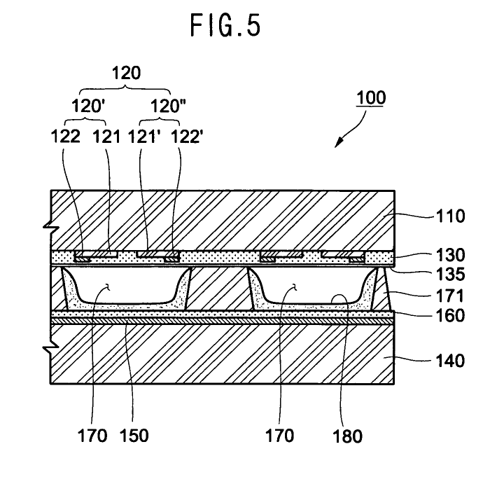

Referring now to FIGS. 2 to 4, three closest discharge cells 170R, 170G, 170B constitute a pixel 190 and have an address electrode pair 151, 152 assigned thereto. In contrast, three address electrodes are assigned to three closest discharge cells (i.e. a pixel) according to the prior art. This means that the number of address electrodes is reduced to ⅔ according to an embodiment of the present invention. More particularly, according to an embodiment of the present invention, one of three closest discharge cells has an address electrode assigned thereto and two remaining discharge cells have another address electrode assigned thereto. For example, a red discharge cell 170R (or red fluorescent layer) has an address electrode 151 assigned thereto, and green and blue discharge cells 170G, 170B (or green and blue fluorescent layers), which are closest to the red discharge cell 170R, have an address electrode 152 commonly assigned thereto. The address electrodes 151, 152 are parallel to each other. Sets of red, green, and blue discharge cells 170R, 170G, 170B (or red, green, and blue fluorescent layers) are repeatedly arranged along the address electrode 151. Similarly, a number of discharge cells are repeatedly arranged along the address electrode 152.

As such, the PDP 100 according to an embodiment of the present invention is advantageous in that, since an address electrode pair is assigned to a pixel, the number of address electrodes is reduced to ⅔, as compared with the prior art, and so is the power consumption. As a result, instantaneous power (or peak power) which must be endured by a circuit for driving the address electrodes, is reduce to ⅔. In addition, the ratio of heat emission from the PDP is substantially reduced.

As the number of address electrodes 150 decreases in the same area, the pitch among them increases and crosstalk among them is substantially reduced.

As shown in FIGS. 2 to 4, the display electrodes 120 are classified into scan electrodes 120′ and sustain electrodes 120″ according to their function. A pair of scan and sustain electrodes 120′, 120″ are assigned to a discharge cell 170. Although the scan and sustain electrodes 120′, 120″ have different functions, the structure is the same and will now be described jointly as display electrodes 120.

As shown, the display electrodes 120 include transparent electrodes 121 and low-resistance bus electrodes 122 for avoiding voltage drop caused by the transparent electrodes 120. The transparent electrodes 121 are formed on a surface of the front glass substrate 110, which corresponds to the discharge cells 170, with a predetermined spacing. The transparent electrodes 121 are formed on both sides of the widest parts of the discharge cells 170, which substantially intersect with the longitudinal direction of the address electrodes 150. Although the transparent electrodes 121 are shown in the drawings to have an approximately square shape, the shape is not limited to that shape. The transparent electrodes 121 may be made of an oxide film of alloy of In and Sn (ITO), Nesa film (SnO₂), or an equivalent thereof, which has good optical transmittance and electrical conductivity, by a spraying method or chemical vapor deposition method. However, the material and formation method are not limited to those materials or techniques.

The bus electrodes 122 and the transparent electrodes 121 are formed on surfaces of the front glass substrate 110 and are connected to one another. The bus electrodes 122 are bent towards the barriers 171 of the discharge cells 170 at a predetermined angle, in order to maximize the gap between the bus electrodes 122 inside the respective discharge cells 170. More particularly, the bus electrodes 122 have slanted and parallel portions 123,124. The slanted portions 123 are formed on a surface of the front glass substrate 110 in a direction slanted away from the barriers 171 of the discharge cells 170. Each slanted portion 123 intersects with the center of a side of a barrier 171, which constitutes the discharge cells 170, so that the bus electrodes 122 have a uniform shape in all discharge cells 170. The parallel portions 124 and the slanted portions 123 are connected to each other and are formed on edge surfaces of the transparent electrodes 121. Each parallel portion 124 is approximately parallel to a side of a barrier 171, which constitutes the discharge cells 170. The parallel portions 124 intersect with (or are perpendicular to) the longitudinal direction of the address electrodes 150. As such, a pair of parallel portions 124 have a relatively large gap defined between them inside each discharge cell 170. As a result of such construction, the bus electrodes 122 have the smallest gap between them when formed on two closest discharge cells (e.g. 170G, 170B) along an address electrode 150. It is to be noted that the smallest gap has no influence on the operation of the PDP, because no sustain discharge is performed between bus electrodes 122 formed on different discharge cells.

Since as large a gap as possible is formed between a pair of bus electrodes 122, which constitute a display electrode 120 inside a discharge cell 170 delimited by barriers 171, the sustain discharge efficiency is substantially improved, and so is the luminance of the PDP.

FIG. 5 is a sectional view showing a PDP according to an embodiment of the present invention.

As is widely known in the art, a frame for displaying images in a PDP includes a number of subfields, each of which includes reset, address, and sustain periods.

In the reset period, the voltage of the scan electrodes 120′ of the display electrodes 120 is gradually increased to a predetermined voltage and is then gradually decreased to another predetermined voltage to erase the wall charge of all discharge cells 170, while maintaining the voltage of the address electrodes 150 at a reference voltage (e.g. OV). This avoids erroneous discharge of the discharge cells 170 in the sustain period, when they do not perform address discharge in the address period.

In the address period, scan and address pulses having predetermined voltages are applied to selected scan and address electrodes 120′, 150, respectively, in order to select which discharge cells 170 to turn on. Then, selected discharge cells 170 generate discharge between the address and scan electrodes 150, 120′, so that positive (+) wall charge is formed on the scan electrodes 120′ and negative (−) wall charge is formed on the address and sustain electrodes 150, 120″. As a result, wall voltage is formed between the scan and sustain electrodes 120′, 120″ in such a manner that the scan electrodes 120 have a higher electrical potential than that of the sustain electrodes 120″.

In the sustain period, pulses having a predetermined voltage are applied to scan electrodes 120′ of the discharge cells 170, which have generated discharge, in order to generate sustain discharge between the scan and sustain electrodes 120′, 120″. As a result of the sustain discharge, negative wall charge is formed on the scan electrodes 120′ and positive wall charge is formed on the sustain and address electrodes 120″, 150, so that the sustain electrodes 120″ have a higher wall voltage than that of the scan electrodes 120′. Then, pulses having a negative voltage are applied to the scan electrodes 120′ to generate sustain discharge between the scan and sustain electrodes 120′ , 120″. Consequently, positive wall charge is formed on the scan electrodes 120′and negative wall charge is formed on the sustain and address electrodes 120″, 150, so that sustain discharge can readily occur when a predetermined voltage is applied to the scan electrodes 120′. Thereafter, the processes of applying sustain discharge pulses having a predetermined voltage to the scan and sustain electrodes 120′, 120″ and applying sustain discharge pulses having a negative voltage thereto are repeated as often as the weight value indicated by the corresponding subfield. It is to be noted that the above description on the reset, address, and sustain periods is only an example, and they may be modified as needed.

As shown in FIG. 5, the display electrodes (i.e. scan and sustain electrodes 120′, 120″) are spaced from the center of the discharge cells 170 as much as possible. In other words, the scan and sustain electrodes 120′, 120″ have a long gap between them. This substantially improves the discharge efficiency when sustain discharge occurs between pairs of display electrodes 120 for image display and increases the degree of openness, because opaque bus electrodes 122, 122′ are formed on the outer periphery of the discharge cells 170, not at the center. Particularly, UV rays are emitted by surface discharge between the scan and sustain electrodes 120′, 120″ and excite fluorescent layers, which emit visible rays after being stabilized. As many visible rays as possible are emitted to the exterior via the front substrate 110. This improves the luminance of the PDP.

As mentioned above, the PDP in accordance with the present invention is advantageous in that, since two address electrodes are assigned to a pixel including three discharge cells, the number of address electrodes is reduced substantially. Particularly, the number of address electrodes of the inventive PDP is reduced to about ⅔, compared with the prior art.

Such reduction of the number of address electrodes is followed by reduction of power consumption of the address electrodes to ⅔.

In addition, the instantaneous power (or peak power), which must be endured by a circuit for driving the address electrodes, is reduce to ⅔.

As a smaller number of address electrodes are used while maintaining the same resolution, the distance between the address electrodes increases. This substantially reduces crosstalk among the address electrodes, as well as heat generation.

Since a pair of bus electrodes, which constitute display electrodes, have as large a gap as possible between them inside a discharge cell including barriers, the sustain discharge efficiency improves substantially, and so does the luminance of the PDP.

As the bus electrodes are formed on the periphery of the discharge cells, not at the center, the area of transmission of visible rays from inside the discharge cells increases and the luminance of the PDP further improves.

Although an exemplary embodiment of the present invention has been described for illustrative purposes, those skilled in the art will appreciate that various modifications, additions and substitutions are possible, without departing from the scope and spirit of the invention as disposed in the accompanying claims.

What is claimed is:

1. A plasma display panel comprising:
a front glass substrate having a front glass substrate surface;
a rear glass substrate having a rear glass substrate surface facing the front glass substrate surface;
discharge cells formed in regions of the rear glass substrate defined by barriers having a predetermined thickness, the discharge cells being adapted to emit predetermined colors of visible rays, three closest discharge cells emitting different colors of visible rays and defining a pixel;
a plurality of display electrodes formed in a first direction on the front glass substrate surface; and
a plurality of address electrodes formed in a second direction on the rear glass substrate surface, the second direction being substantially perpendicular to the first direction;
wherein two of the plurality of address electrodes are associated with each pixel, one of the two of the plurality of address electrodes being associated with a respective discharge cell of the pixel, the other of the two of the plurality of address electrodes being associated with the other two discharge electrodes of the pixel,
wherein a pair of display electrodes of the plurality of display electrodes are associated with the respective discharge cell, the direction of the pair of display electrodes intersecting within a respective discharge cell with a direction of the one of the two of the plurality of address electrodes associated with the respective discharge cell, and wherein the display electrodes extend towards a periphery of each discharge cell at a center region of the discharge cell such that an increased gap is provided between the display electrodes inside the discharge cell.

2. The plasma display panel as claimed in claim 1, wherein an address electrode is commonly assigned to two selected discharge cells of the three discharge cells defining a pixel, and the other of the two of the plurality of address electrode is assigned to a remaining discharge cell of the pixel, the address electrode commonly assigned being substantially parallel with the other address electrode.

3. The plasma display panel as claimed in claim 1, wherein the discharge cells have a polygonal shape enclosed by the barriers.

4. The plasma display panel as claimed in claim 1, wherein the display electrodes comprise:
bus electrodes; and
transparent electrodes extending from the bus electrodes within the discharge cell,
wherein the bus electrodes extend along the periphery of each discharge cell at the center region of the discharge cell such that the increased gap is provided between the display electrodes inside the discharge cell.

5. The plasma display panel as claimed in claim 4, wherein the transparent electrodes extend from the bus electrodes at the widest parts of the discharge cells, the widest parts intersecting with second direction.

6. The plasma display panel as claimed in claim 4, wherein the bus electrodes comprise:
parallel portions formed at the periphery of each discharge cell at the center region of the discharge cell; and
slanted portions connected to the parallel portions and extending outside the discharge cell.

7. The plasma display panel as claimed in claim 6, wherein each slanted portion of the bus electrodes extends outside the discharge cell through a center of a side of a barrier defining the discharge cell.

8. The plasma display panel as claimed in claim 6, wherein a gap between the parallel portions of the bus electrodes inside each discharge cell is larger than a gap between parallel portions of adjacent bus electrodes of two adjacent discharge cells adjacent the each discharge cell and adjacent to each other along the second direction.

9. The plasma display panel as claimed in claim 6, wherein the parallel portions extend in the first direction.

10. A method for reducing address electrode power consumption while improving discharge efficiency and illuminance of a plasma display panel having discharge cells formed in regions of a rear glass substrate defined by barriers having a predetermined thickness, the discharge cells being adapted to emit predetermined colors of visible rays, three closest discharge cells emitting different colors of visible rays and defining a pixel, a plurality of display electrodes being formed in a first direction on the front glass substrate surface; and a plurality of address electrodes being formed in a second direction on the rear glass substrate surface, the second direction being substantially perpendicular to the first direction, the method comprising:
associating two of the plurality of address electrodes with each pixel, one of the two of the plurality of address electrodes being associated with a respective discharge cell of the pixel, the other of the two of the plurality of address electrodes being associated with the other two discharge electrodes of the pixel;
associating a pair of display electrodes of the plurality of display electrodes with the respective discharge cell, the direction of the pair of display electrodes intersecting within a respective discharge cell with a direction of the one of the two of the plurality of address electrodes associated with the respective discharge cell; and
extending the display electrodes towards a periphery of each discharge cell at a center region of the discharge cell such that an increased gap is provided between the display electrodes inside the discharge cell.
